(19) United States
(12) Patent Application Publication
(10) Pub. No.: US 2022/0083936 A1
(43) Pub. Date: Mar. 17, 2022

(54) ACCESS CONTROL METHOD

(71) Applicant: Hewlett-Packard Development Company, L.P., Spring, TX (US)

(72) Inventors: Helen Balinsky, Bristol (GB); Josep Abad Peiro, Sant Cugat del Valles (ES); Remy Husson, Bristol (GB)

(73) Assignee: Hewlett-Packard Development Company, L.P., Spring, TX (US)

(21) Appl. No.: 17/420,067

(22) PCT Filed: Jan. 9, 2019
(86) PCT No.: PCT/US2019/012918

§ 371 Date: Jun. 30, 2021

(51) Int. Cl. G06Q 10/06; H04L 9/08; H04L 9/30

(52) U.S. Cl. CPC G06Q 10/06311; H04L 9/30; H04L 9/088

(57) ABSTRACT

In an example, there is provided a method for creating a workflow, comprising workflow tasks. The method comprises assigning workflow tasks to workers, according to an access control policy. The method comprises encoding as a transaction to a secure ledger that access to the workflow is granted to a worker to perform a workflow task and enforcing access control on execution of the workflow task according to the transaction encoded to the secure ledger.

### BACKGROUND

Access control is widely deployed in both physical and digital contexts. Implementing good access control policies is of utmost importance in a highly digitalized commercial environment. Businesses implement access control policies so that employees and other parties performing tasks have the appropriate access rights for their roles. Business workflows can involve a large number of parties, often across international boundaries. In this context, access control management is implemented to ensure workflows are properly executed.

### BRIEF DESCRIPTION OF THE DRAWINGS

FIG. 1 shows an apparatus for implementing access control, according to an example.

FIG. 2 shows a block diagram of a method of implementing access control using a secure ledger, according to an example.

FIG. 3 shows a processor associated with a memory and comprising instructions for performing maintenance of firmware on a computing device.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

As business workflows become more decentralized and segregated it becomes harder to ensure that access control policies are correctly implemented. This particularly becomes an issue where aspects of a workflow are outsourced to a third party. In this context, it may be difficult to have guarantees that access control has been properly implemented, since the management of the access control policy relies on cooperation with a third party. In recent years, secure ledger or “blockchain” technology has become increasingly prevalent. Secure ledgers can be used in a diverse range of contexts to provide guarantees that certain processes have properly been executed and that tasks have been carried out according to a well-defined process. Secure ledgers implement cryptographic hash functions to ensure the integrity of a process or data represented in the ledger.

Secure ledgers may implement a system where timestamps could not be tampered with at a later point in time. The functionality that could be implemented using ledgers also includes providing a tamper-proof record based on timestamps.

A secure ledger may be implemented as follows: the output of a record of an earlier transaction in the ledger is hashed and is used as an input to the next block in a chain. Further data may be input into the next block such a record that a further transaction has occurred. This creates a secure-by-design process where the integrity of any point of the chain can be verified by recomputing hash values on inputs and checking the recomputed hash values against the ledger. In certain examples it is sufficient to check the final output against the last recorded item on the ledger based on the inputs.

Another feature of an example secure ledger is that the ledger may be stored in a decentralized fashion. For example, the ledger can be stored across a peer-to-peer network where nodes hold their own copy of the ledger and can collectively verify the authenticity of alleged transactions by recomputing ledger data.

Using secure ledgers, it is possible to execute whole protocols and maintain a verifiable record of each step of the protocol. For example, “smart contracts” allow the digital facilitation, verification and/or enforcement of the negotiation or performance of a contract. Smart contracts allow the performance of credible transactions without third parties such as legal entities being involved. Decentralized cryptocurrencies such as Bitcoin may be considered a form of smart contract between participants. Bitcoin and other cryptocurrencies implement a secure ledger which provides a secure and verifiable transaction history which may be verified by anyone at a later point in time.

Ledger technology digitizes and simplifies many processes which would previously have involved trusted third-party verification to perform securely. Secure ledgers provide a higher degree of certainty for participants and provide greater security over trusted third-party models.

Access control systems may include both physical and information security-related access control. For example, users of computing systems will frequently have a large number of passwords which grant them access to the systems and programs on a business's network.

Access control systems may implement role or policy-based access control which controls user access to the systems based on their job role. For example, system administrators will have full access rights which allows them access to all systems on their networks. Lower level employees will be provided access to a subset of systems or areas of a building which allow them to perform their work tasks.

In the context of a workflow in a business, different employees and/or third parties may be granted access to a subset of systems for a period of time to allow them to perform their tasks within the workflow. For example, in a workflow for developing a new webpage of a company website, a third-party web designer may be granted access to a specification provided for by the business which details requirements for their website. The third-party web designer may then sub-divide and delegate roles to certain employees, such as web developers and graphics designers who have access to specific tools within their work environments to allow them to perform tasks. This may include access to confidential information provided by the business and/or proprietary software tools. In particular, it is desirable, in such circumstances to be able to implement access control across the workflow according to an access control policy.

Methods and systems described herein may be used to provide secure ledger enforced access control across digital and physical workflows. The methods and systems described use secure ledger technology to support, enforce and ruggedize business workflows. The methods described herein can be used in multi-step workflows which incorporate a combination of physical steps and digital steps across multiple business entities. For example, in a manufacturing pipeline, the design phase is typically implemented in a purely digital environment and the manufacturing phase will be outsourced overseas to a third party.

Business workflows have an owner and/or administrator who defines the workflow. Defining a workflow may include specifying a workflow from a workflow template. The administrator or owner may specify as part of the workflow one or more: workflow tasks, workers, roles of workers, the order of operations occurring in the workflow, which tasks of the workflow are to be performed by which worker or group of workers etc. These attributes specify what is required to accomplish a particular workflow.

Methods and systems described herein introduce secure ledger-enforced access control on the workflows. The assignment of workflow tasks across the workflow or individual sub-workflows are recorded as transactions in a secure ledger by a workflow master. Access can be granted to add a particular transaction, group of transactions, or query within a scope of a particular workflow or secure ledger.

In certain cases, access can be granted for single or multiple workers of a particular workflow transaction or group of workflow actions. For example, the ability to add new workers within a particular organization as part of a workflow may be granted for a limited time period or permanently to a manager as part of an access control policy. Revocation could be applied at any moment in time, by adding a direct revocation transaction to the secure ledger for a particular worker or a particular role. In another case revocation could be applied by resetting access control within a defined scope to a new access control regime.

All transactions that are carried out with respect to a particular workflow are recorded in a secure ledger. This ledger becomes a secure record for the duration of the workflow, and can be verified simply by determining that the output of the ledger is as expected based on the inputs of and the particular expected tasks of the workflow. Thus, if a particular user who was unauthorized to perform a task, or an altogether unauthorized user tried to gain access rights to part of the workflow, they could be challenged against the content of the secure ledger.

Access requests can also be added to the ledger as well as transactions confirming the task completion. The completion of task with assigned access control means termination of access rights to a particular worker to a particular step and or to the entire workflow, if there are no steps assigned to the worker.

Thus, the methods and systems described herein can be used to securely implement access control across a workflow which may comprise a complex interlinked web of tasks performed across international borders, and incorporating many different elements and users.

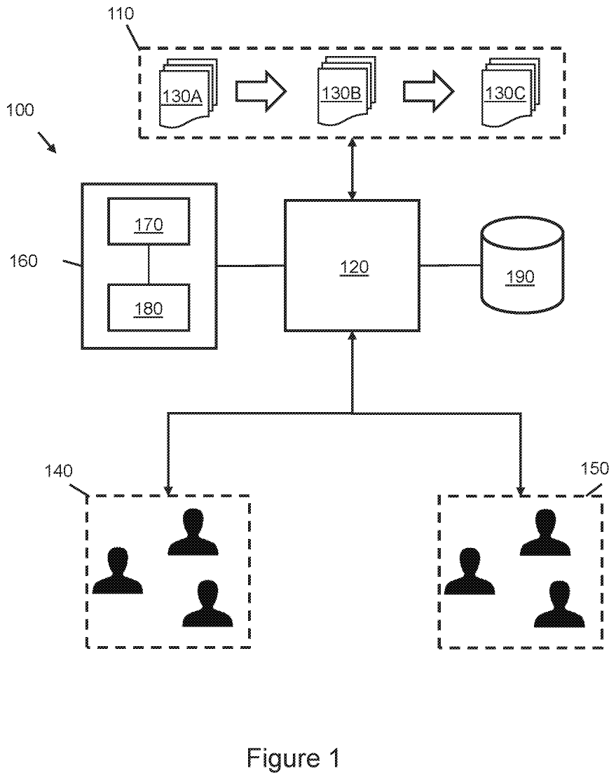

FIG. 1 shows an apparatus 100 for implementing access control, according to an example. In the example shown in FIG. 1 there is shown a workflow 110 and a workflow controller 120. In one example, the workflow controller 120 is implemented in software on a computing system, which is stored on a non-transitory medium. The workflow controller 120 is arranged to manage the workflow 110. The workflow 110 comprises workflow tasks 130A-130C. Each workflow task 130 may comprise a combination of actions performed, for example, on computing systems, and physical tasks in the real world. Tasks may be automated, or tasks may be performed by a machine. For example, in a manufacturing workflow, some workflow tasks will be performed on a machine or by hand and other workflow tasks will be preformed on a computing system.

The workflow controller 120 is arranged to manage the workflow 110 in a computing environment. This includes, for example, maintaining a view of the workflow 110 on the computing system that the workflow controller 120 is implemented on. Managing the workflow 110 comprises determining when tasks have been completed, managing the different stages of the workflow, and determining which users and systems have access to workflow components. In the present context a “worker” may be an actual human operator or a software or hardware component which is involved in a workflow.

In FIG. 1 there are shown two groups of workers 140, 150 which are in communication with the workflow controller 120. The workers 140 may be users within a first organisation which are performing actions to execute one or more of the workflow tasks 130. Similarly, the workers 150, may be workers within a second organisation which are performing a different set of actions as part of the workflow tasks.

The management and coordination of the workers 140, 150 with respect to the workflow 110 is managed via the workflow controller 120. For example, a request to start a new workflow from a worker in either of the groups 140, 150 is sent to the workflow controller 120. The workflow controller 120 is arranged to determine whether to allow the worker to execute a request with respect to a workflow or workflow task, as will further be described.

In FIG. 1 there is shown an access control module 160. The access control module 160 is communicatively coupled to the workflow controller 120. The access control module 160 may be implemented in software similarly to the workflow controller 120. The workflow controller 120 is arranged to communicate with the access control module 160 to determine whether to grant access to a worker to the workflow 110.

The access control module 160 comprises an access control policy storage 170 arranged to store access control policies. The access control policy storage 170 may be implemented in memory of a computing system which implements the apparatus 100. Access control policies that are stored by the access control policy storage 170 comprise a specification of access rights for users. This may include qualifiers, constraints and limitations for workflow creation. This may further specify that access can be granted to a worker or group of workers for a fixed time period to perform tasks in the workflow 110. According to examples described herein an access control policy can be static or dynamically updated.

The access control module 160 further comprises an access control management module 180 which is communicatively coupled to the access control policy storage 170. According to examples herein the access control management module 180 is arranged to manage access control policies that are stored in the access control policy storage 170. This may include supplying data relating to the access control policies in the access control policy storage 170 to the workflow controller 120 upon request.

The apparatus 100 shown in FIG. 1 further comprises a secure ledger 190. The secure ledger 190 comprises a record of all workflow related transactions. This includes a record of the creation of the workflow 110, and any further transactions such as the assignment of workflow tasks to workers by the workflow controller 120, which roles have been assigned to workers, subsequent request made by workers, and subsequent revocation of access rights when the worker access rights become invalidated or voided by an administrator. According to examples described herein the workflow controller 120 is arranged to compute an initial entry on the secure ledger 190 as a function of an input associated to a creation of the workflow 110.

The secure ledger 190 comprises a trackable and auditable ledger of every workflow-related transaction. The function of the input may be computed using, for example a secure cryptographic hash function. According to examples a secure ledger may be implemented as a blockchain or a hash chain. Subsequent workflow-related transactions may be recorded to the secure ledger 190 as a function of previous entries on the secure ledger 190 and new inputs such as worker identifiers, workflow task-related identifiers etc.

According to examples described herein, the workflow controller 120 is arranged to determine whether workers have access rights according to a particular access control policy in response to a request from a worker. In this case, the workflow controller 120 is arranged to read the contents of the secure ledger 190 to determine, based on the access control whether that worker was assigned the workflow task. In particular, the workflow controller 120 is arranged to provide secure ledger-based access control enforcement for workflow tasks, execution and queries concurrently with the access control module 160 and secure ledger 190.

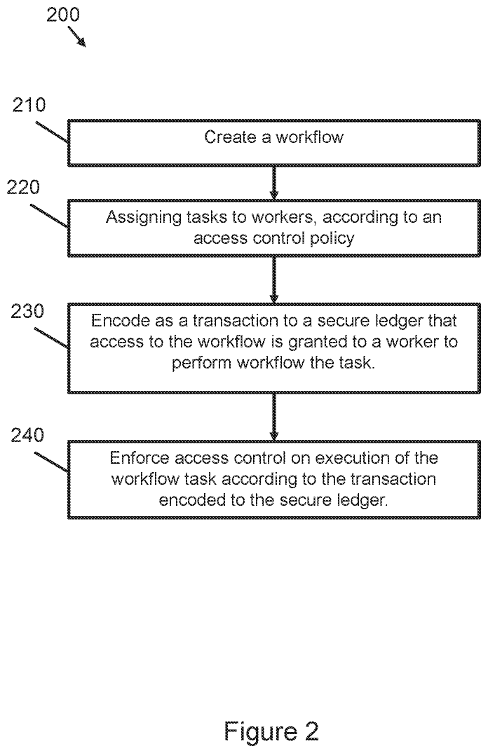

FIG. 2 shows a block diagram of a method of implementing access control using a secure ledger, according to an example. According to an example, the method 200 is implemented on the apparatus 100 shown in FIG. 1. At block 210, a workflow such as the workflow 110 shown in FIG. 1 is created. The workflow comprises one or more workflow tasks. When the method 200 is implemented on the apparatus 100 shown in FIG. 1, the workflow 110 may be created by a workflow administrator using the workflow controller 120. According to examples described herein a workflow is created according to a workflow template. A workflow template may specify a standardised workflow routine with well-defined roles and access rights for users within the workflow.

At block 220 a task is assigned to a worker, according to an access control policy. When the method 200 is implemented on the apparatus 100 shown in FIG. 1, the workflow controller 120, determines, via the access control management module 180, which tasks are assigned to which workers, according to an access control policy stored in the access control policy storage 170. According to examples, the worker is a service, a user, a role, or an entity associated to the execution of the workflow task.

At block 230, the method 200 comprises encoding as a transaction to a secure ledger that access to the workflow is granted to a worker to perform the workflow tasks based on the assigned role. In the context of the apparatus 100 shown in FIG. 1 the workflow controller 120 is arranged to encode to the secure ledger 190 that access is granted according to the access control policy, which determines the access rights for a given assigned task and worker.

According to examples described herein, encoding to a secure ledger comprises computing an initial entry to the secure ledger as a function of an input associated to the creation of the workflow. In further examples, encoding to a secure ledger comprises computing a subsequent entry to the secure ledger as a function of at least the previous entry on the secure ledger.

In other cases, recording to the secure ledger comprises adding a permanent record, a transaction or a block. In a further example the record contains a worker's identifier or form of identity. The identity may be a worker's public key or another verifiable form. According to example, the record further stipulates that rights are granted or revoked to execute a part or whole of a workflow. According to an example, the record further contains constraints, which must be satisfied for the access to be granted. In some cases the record is signed or certified by a workflow administrator, owner or other authorized worker.

According to examples, the function of the input is a cryptographic hash function. The input associated to the creation of a workflow comprises at least one of a user identifier, attribute or role, and/or workflow task identifier or workflow attribute.

At block 240, the method 200 comprises enforcing access control on execution of the workflow task according to the transaction encoded to the secure ledger. In the context of apparatus 100, block 240 is implemented by the workflow controller 120 when the method 200 is implemented on the apparatus 100.

According to an example, enforcing access control comprises: receiving a request to perform a workflow task from a worker and determining whether to grant access to perform the workflow task on the basis of the content of the secure ledger. In certain cases, this may comprise recomputing one or more values associated to the worker to determine if the content of the secure ledger matches the output of the alleged inputs. In the case that there is not a match between the output values, a worker will not be granted access rights to perform whichever tasks of the workflow they wish to perform.

According to a further example, enforcing access control comprises revoking access for a worker to perform workflow tasks based on the assigned role. Revoking access may be performed as a result of a change of worker roles e.g. as a result of a change in employment status within an organisation. Alternatively, revocation may result from a violation by a worker of a policy or because an access control policy has been updated.

According to examples, enforcing access control is defined as determining whether to allow or deny a worker to perform actions required to perform an assigned task. According to examples, a task may comprise editing, approving or printing a document or to approve it or to print it, etc. In certain cases, the method comprises granting access to the corresponding digital asset. The digital asset may comprise one or more documents or images. In examples, the entity where the asset is stored checks the corresponding ledger records then the access to the asset is granted to the requesting worker.

The methods and systems described herein can be used to support access control across a workflow. The methods described, provide a means of producing a fully trackable and auditable access control regime for a workflow using a secure ledger. Advantageously, the methods described allow a workflow administrator to define roles and record information as secure ledger transactions. Subsequent access control is enforced according to the most up to date secure ledger transactions. Furthermore, certain examples described herein allow access rights to be revoked or access rights to be invoked or revoked dynamically according to an updated access control policy.

Certain methods leave no immutable and verifiable record of workflow related transactions. In contrast, the methods and systems described herein provide improved security guarantees over conventional methods by utilizing a secure ledger to enforce access rights and to provide an immutable record.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

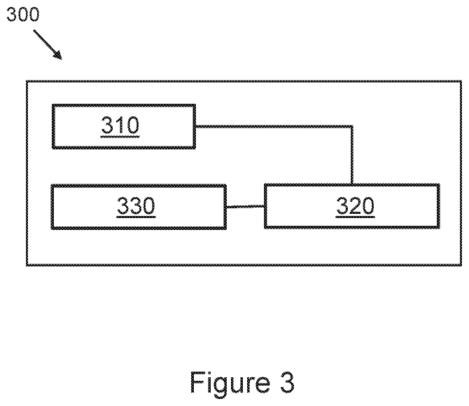

FIG. 3 shows an example of a processor 310 associated with a memory 320. The memory 320 comprises computer readable instructions 330 which are executable by the processor 310. The instructions 330 comprise instruction to, at least specify a workflow, allocate roles to workers, based on worker identifiers, according to security requirements for the workflow, register to a secure ledger that access to the workflow is granted to a worker to perform workflow tasks based on the assigned role, and determine whether to grant access to a worker to perform a workflow task on the basis of the secure ledger.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method, comprising:
creating a workflow, comprising workflow tasks;
assigning workflow tasks to workers, according to an access control policy;
encoding as a transaction to a secure ledger that access to the workflow is granted to a worker to perform a workflow task; and
enforcing access control on execution of the workflow task according to the transaction encoded to the secure ledger.

2. The method of claim 1, wherein the worker is a service, a user, a role, or an entity associated to the execution of the workflow task.

3. The method of claim 1, wherein the transaction or any subsequent derived transaction depends on a time period constraint, geographical constraint and/or physical constraint.

4. The method of claim 1, wherein the worker is identifiable by a public key, associated to a public/private key pair of the worker.

5. The method of claim 1, wherein enforcing access control comprises:
receiving a request to perform a workflow task from a worker; and
determining whether to grant access to perform the workflow task on the basis of the content of the secure ledger.

6. The method of claim 1, wherein the workflow is created from a workflow template.

7. The method of claim 1, wherein recording to secure ledger comprises,
computing an initial entry to the secure ledger as a function of an input associated to the creation of the workflow.

8. The method of claim 7, wherein recording to the secure ledger comprises:
computing a subsequent entry to the secure ledger as a function of at least the previous entry on the secure ledger.

9. The method of claim 8, wherein enforcing access control comprises recomputing the function on a set of inputs and comparing to entries recorded on the secure ledger.

10. The method of claim 7 wherein the function is a cryptographic hash function.

11. The method of claim 7, wherein the input comprises at least one of: a worker identifier, attribute or role, and/or workflow task identifier or workflow attribute.

12. The method of claim 1, wherein enforcing access control comprises revoking access for a worker to perform workflow tasks based on an assigned role.

13. An apparatus comprising:
a workflow controller arranged to manage a workflow;
an access control module communicatively coupled to the workflow controller, comprising:
an access control policy storage arranged to store access control policies; and
an access control management module arranged to manage access control policies; and
a secure ledger comprising a record of workflow related transactions,
wherein the workflow controller is arranged to access the secure ledger and communicate with the access control module to determine whether to grant access to a worker to the workflow.

14. The apparatus of claim 13, wherein the workflow controller is arranged to:
receive a request to perform a workflow task from a worker;
determine whether to grant access to perform the workflow task on the basis of the content of the secure ledger.

15. A non-transitory machine-readable storage medium encoded with instructions executable by a processor, to:
specify a workflow;
allocate roles to workers, based on worker identifiers, according to security requirements for the workflow; and
register to a secure ledger that access to the workflow is granted to a worker to perform a workflow task based on the assigned role.
